(19) United States
(12) Patent Application Publication
(10) Pub. No.: US 2023/0213546 A1
(43) Pub. Date: Jul. 6, 2023

(54) IMPACT SENSOR ACTIVATIONS

(71) Applicant: HEWLETT-PACKARD DEVELOPMENT COMPANY, L.P., Spring, TX (US)

(72) Inventor: Elizabeth Elias Benedetto, Fort Collins, CO (US)

(73) Assignee: HEWLETT-PACKARD DEVELOPMENT COMPANY, L.P., Spring, TX (US)

(21) Appl. No.: 17/569,437

(22) Filed: Jan. 5, 2022

(51) Int. Cl. G01P 1/12; G01P 15/18; G01P 13/00

(52) U.S. Cl. CPC G01P 1/127; G01P 15/18; G01P 13/00

(57) ABSTRACT

An example computing device includes a motion sensor to detect movement of a computing device. The computing device also includes an example processor to 1) determine a rate of movement change of the computing device and 2) activate an impact sensor of the computing device responsive to the determined rate of movement change being greater than a threshold rate. The example computing device includes an impact sensor to detect an impact of the computing device and record data associated with the impact.

### BACKGROUND

Computing devices include hardware components that individually and collectively execute a wide variety of computing operations. For example, a computing device may include a processor, a memory device, a graphics card, a sound card, transistors and circuitry to connect these and other hardware components. The interoperation of these hardware components provides a user with a wide variety of computing operations that may be executed. While specific reference is made to particular hardware components in a computing device, a computing device may include any variety of hardware components to allow a user to carry out a variety of intended operations.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 depicts a computing device for activating an impact sensor, according to an example.

FIGS. 2A-2C depict an environment for activating an impact sensor, according to an example.

FIG. 3 is a flowchart of a method for activating an impact sensor, according to an example.

FIG. 4 depicts a computing device for activating an accelerometer, according to an example.

FIG. 5 depicts a non-transitory machine-readable storage medium for activating an accelerometer, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices are used by millions of people daily to carry out business, personal, and social operations and it is not uncommon for an individual to interact with multiple computing devices on a daily basis. Examples of computing devices include desktop computers, laptop computers, all-in-one devices, tablets, and gaming systems to name a few. A computing device may include any number of hardware components. These hardware components operate with other hardware components to execute a function of the computing device. For example, a memory device may include instructions that are executable by a processor. The instructions when executed by the processor, may cause the processor to execute an operation on the computing device. As specific examples, the computing device includes processors, memory devices, fans, and other integrated circuits. A computing device also includes circuitry to interconnect the hardware components. While specific reference is made to particular hardware components, a computing device may include any number and any variety of hardware components to carry out an intended function of the computing device.

As computing devices are becoming more ubiquitous in society, some developments may further enhance their integration. For example, hardware components are susceptible to mechanical damage. As such, these hardware components may be come damaged or inoperable responsive to being dropped from elevation.

As computing devices become more transportable, the risk of hardware components being dropped and damaged increases. Hardware components may be negatively impacted or may fail due to the effects of a single impact or the aggregate effect of multiple impacts. Once a hardware component fails, a user is left without a computing device until a replacement hardware component or computing device may be acquired. During such downtime, user productivity is reduced or altogether halted. Failed hardware components may even risk data loss and represents an unintended and undesirable cost to the user.

Accordingly, predicting failures of computing devices and the hardware components contained therein may increase computing efficiency by 1) reducing the downtime associated with remedying a damaged or broken hardware component and 2) designing hardware components to be more robust against mechanical damage.

Accordingly, the present specification provides for the in-field prediction of component failures before they occur. Specifically, the present computing device includes an accelerometer that can detect an impact, such as dropping the computing device from a certain height, and can map the impact, force of the impact, and quantity of impacts to a predicted end of life for a component of the computing device.

Rather than having the accelerometer constantly activated to detect movement of the computing device, which may drain the battery of a computing device, the present computing device also includes a motion sensor. When the motion sensor detects am impending fall, for example by measuring an acceleration that is above what would be expected during usage of the computing device, a processor of the computing device activates the accelerometer or other impact sensor to begin detecting accelerations such that data regarding a collision with a hard surface may be tracked. Based on accelerometer output indicating a force of the impact, an end of life for the computing device or a computing device component may be predicted. As described above, such a prediction may be used in a number of ways for example to provide a user with a recommendation, i.e., replace a part that has been impacted by the impact or history of impacts. In another example, the impact data may be used to re-design computing devices or computing device components to make them more robust against impact events.

In one particular example, a motion sensor, such as an elevation sensor may feed expected elevation changes to a machine-learning device which is trained on the expected elevation change data. During use, the processor may recognize whether a target elevation change rate is outside the bounds of an expected elevation change rate. If so, the processor may turn on an accelerometer, which may collect data leading up to and including an impact of the computing device. The data may be compared to historic data to determine whether a dangerous or damaging event has occurred and/or indicate the effect of the impact on the life of the computing device or computing device components.

Specifically, the present specification describes a computing device. The computing device includes a motion sensor to detect movement of a computing device. The computing device also includes a processor to 1) determine a rate of movement change of the computing device and 2) activate an impact sensor of the computing device responsive to the determined rate of movement being greater than a threshold rate. The computing device also includes the impact sensor to detect an impact of the computing device and record data associated with the impact.

In another example, the computing device includes an elevation sensor to detect an elevation of a computing device and an accelerometer to detect a change of acceleration of the computing device to detect an impact of the computing device. In this example, the processor determines a rate of elevation change of the computing device and activates the accelerometer responsive to the determined rate of elevation change being greater than a threshold rate. The processor also 1) classifies a severity of the impact, 2) generates an impact history profile for the computing device based on accelerometer output data, and 3) predicts an end of life of a computing device component based on the impact history profile. In this example, the computing device includes a database to store the accelerometer output data.

The present specification also describes a non-transitory machine-readable storage medium encoded with instructions executable by a processor of a computing device. The instructions, when executed by the processor, cause the processor to collect data indicative of movement of the computing device and calculate, using machine-learning and based on data indicative of movement of the computing device, a threshold rate of elevation change to trigger activation of the accelerometer. The instructions are also executable to detect an elevation of the computing device and determine a rate of elevation change of the computing device. Responsive to the determined rate of elevation change being greater than a threshold rate, the instructions are executable to activate an accelerometer of the computing device. The instructions are executable by the processor to detect a change of acceleration of the computing device to identify an impact of the computing device and classify a severity of the impact. The instructions are also executable to predict an end of life of a computing device component based on an identified impact.

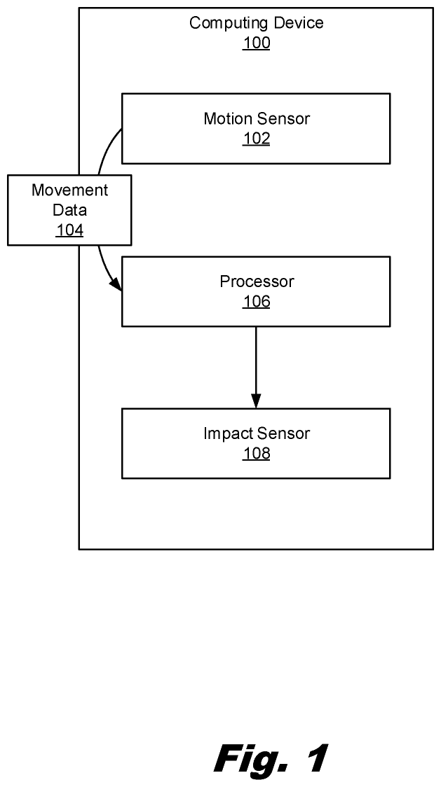

Turning now to the figures, FIG. 1 depicts a computing device 100 for activating an impact sensor 108, according to an example. The computing device 100 may be of a variety of types including a desktop computer, laptop computer, all-in-one device, tablet, mobile devices, smartphones, or gaming system to name a few.

Computing devices 100 include components that are susceptible to damage from a “shock event,” which shock event may be a fall from a certain elevation. Those computing devices 100 that are portable such as laptop computers, tablets, and smart phones may be more susceptible to drop-related shock events. Accordingly, the computing device 100 includes an impact sensor 108 to record information of an impact or fall. However, rather than being continuously actively, the impact sensor 108 may be activated, for example, responsive to the initiation of a fall. That is, before the computing device 100 falls from a particular height, the impact sensor 108 may be inactive. As the computing device 100 begins to fall, the impact sensor 108 may be activated such that by the time the impact occurs, the impact sensor 108 is actively collecting data regarding a time, force, and nature of the impact. As described above, based on the collected data, a notification or recommendation may be provided, or another action may be carried out.

Accordingly, the computing device 100 includes a motion sensor 102 to detect movement of the computing device. The motion sensor 102 may detect movement in any variety of planes. For example, the motion sensor 102 may detect movement in a horizontal plane, for example, as the computing device slides across a surface to hit a wall.

In another example, the motion sensor 102 may be an elevation sensor to detect an elevation of the computing device 100. An elevation sensor detects a height of the computing device. As a particular example, air pressure changes with elevation. That is, at a higher elevation, there is less air pressure. Accordingly, an elevation sensor may measure the air pressure at the computing device 100 and correlate the air pressure measurement to an elevation. In some examples, the elevation sensor is a high-resolution elevation sensor. That is, the elevation sensor may differentiate elevation at 2-foot increments, 1-foot increments, or other increment. Put another way, the elevation sensor may determine when the computing device elevation has changed by as small as two feet, one foot, or some other value. In so doing, once a computing device 100 has fallen the increment in a threshold time, the impact sensor 108 may be activated. As such, the elevation sensor may make a determination of elevation change in a short amount of time, for example on the order of microseconds. Responsive to this determination, the processor 106 may activate the impact sensor 108 all while the computing device 100 is falling.

While particular reference has been made to a particular motion sensor 102 and a particular elevation sensor, other types of sensors may be implemented herein to determine a movement of the computing device.

The movement data 104 is transmitted to the processor 106 which acts upon the movement data 104. Specifically, the processor 106 determines a rate of movement change of the computing device 100. That is, during use, a computing device 100 may be moved. For example, a user may take a laptop computing device 100 from off of a desk and place the computing device 100 in a carrying case which is on the ground. A computing device 100 may be designed for this type of movement and as such there is not likely to be an impact which would affect computing device performance. However, a computing device 100 that is knocked off the desk moves the same distance, i.e., from a desk onto a backpack on the ground. This fall may have an impact on the computing device performance due to the rate of movement change. That is, it is not the elevation change itself that results in damage to the computing device 100, but the rate at which the computing device 100 falls and contacts the surface. Accordingly, using the movement data 104, the processor 106 determines a rate of movement change of the computing device 100. That is, the motion sensor 102 may be continuously active and passing data to the processor 106. Responsive to the determined rate of change being greater than a threshold, the processor 106 may activate the impact sensor 108 of the computing device 100. In some examples, the threshold may be 32 feet per second, or the rate of acceleration due to gravity. Accordingly, rather than being active continuously, the impact sensor 108 is active just following initiation of a fall of the computing device 100 or some other abrupt movement of the computing device 100.

In some examples, the processor 106 may rely on machine-learning. As described above, the processor 106 may compare the actual rate of elevation change with a threshold rate. The threshold rate may delineate between those rates that are expected, i.e., that one would expect to occur during usage of the computing device for example via placement in a bag, etc. vs. a rate that is likely to result in an impact and damage to the computing device 100. A machine-learning device may be trained to determine the threshold rate. For example, during a calibration period, the motion sensor 102 may pass movement data 104 to the processor 106 such that the processor 106 may determine the day-to-day movements of the computing device 100 to determine which are reportable, i.e., likely to result in impact and damage to computing device components and which are not-reportable, i.e., not likely to result in impact and damage to computing device components. Accordingly, the motion sensor 102 and the processor 106 may determine the threshold rate during a calibration period and based on a usage of the computing device 100.

In other examples, the threshold rate may be a manufacturer-set threshold value. For example, metadata in the computing device 100 may indicate which elevation change rates are likely to result in damage to computing device components. Accordingly, the processor 106 may program this manufacturer set value as the threshold rate. In either example, the processor 106 may activate the impact sensor 108 based on a comparison of the threshold rate with the movement data 104 from the motion sensor 102.

The computing device 100 also includes an impact sensor 108 to detect an impact of the computing device 100 and record data associated with the impact. In general, a shock event or impact is measured via acceleration, which has a unit of gravitational force (gs). The impact sensor 108 may the extent of the impact over time, which may have units of milliseconds (ms). The output of the impact sensor 108 may therefore be a graph where g is the amplitude, and the width of the peak is the time. An example of an impact could be a 100 g force over 2 ms. The force of an impact that would result to damage to the computing device 100 or computing device component may be determined as described below.

That is, the impact of the computing device 100 which may lead to component damage is a change in the acceleration, which change of an acceleration to 0 may indicate a sudden contact with a rigid surface. Accordingly, as the computing device 100 is falling, the impact sensor 108 may record an acceleration. The rate at which the acceleration changes to zero may indicate a strength of the force of the impact. In other words, the output of the accelerometer may be a change in acceleration value or a force value of an impact. In an example, the impact sensor 108 may be a multi-axis accelerometer. That is, the multi-axis accelerometer may detect vertical movement changes, horizontal movement changes, and rates of change in either direction.

As described above, the information collected by the impact sensor 108 may be used in any variety of ways. In one example, a notification may be generated for the user which indicates the nature of the impact and may indicate any effect the impact has had on the predicted end of life of the component. As such, a user may plan for the expected end of life of the computing device component and may avoid the loss of efficiency and productivity that may result from the downtime in addressing a failed or failing computing device 100.

As another example, the notification may be passed to a remote site such as to a manufacturer of the computing device 100 and/or component to provide telemetry data used in updating the computing device 100 and/or component. For example, the computing device component design may be changed, or the position of the computing device component within the computing device 100 may be updated. Such updates may result in higher quality products and more efficient product development. As such, the present computing device 100 may assess whether a system failure was due to customer induced damage and may be used to predict long-term reliability issues prior to system failure.

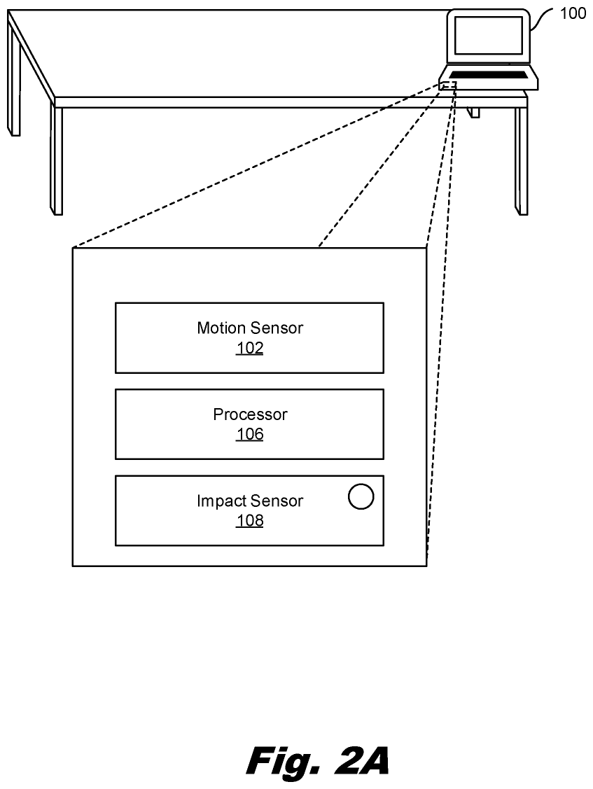

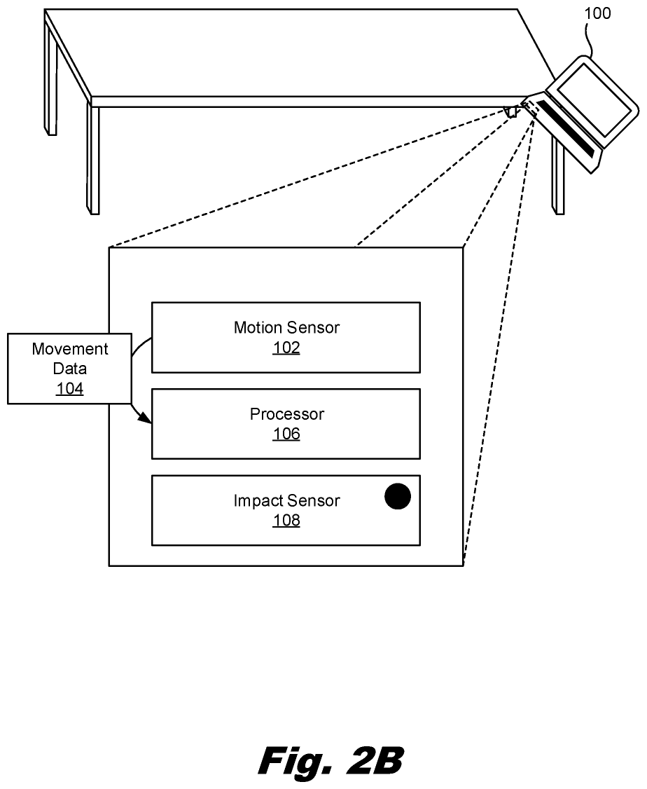

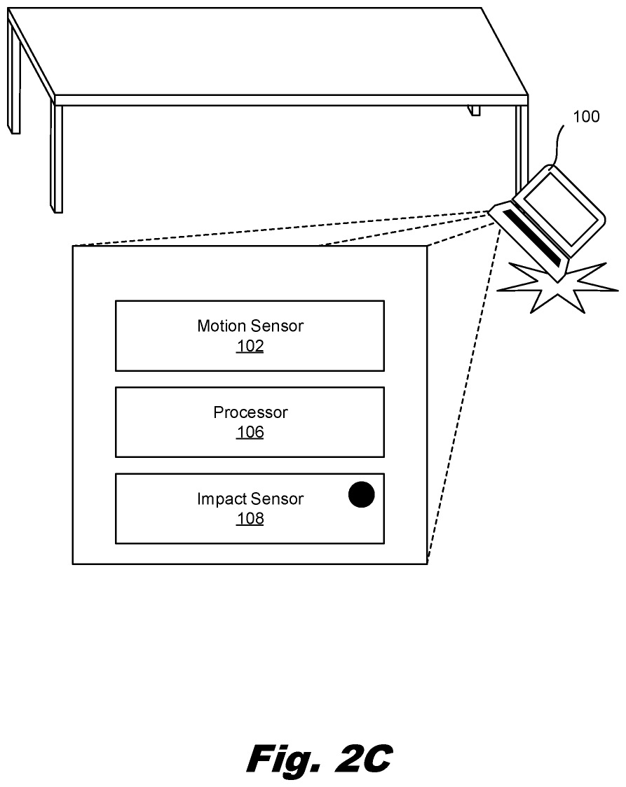

FIGS. 2A-2C depict an environment for activating an impact sensor 108, according to an example. As described above, were the impact sensor 108 continually active, the impact sensor 108 would draw power continuously, even when not recording impact related data. As such, a continuously active impact sensor 108 is not energy efficient.

Moreover, were the impact sensor 108 continually active, the impact sensor 108 may be recording data continuously, even though no impact events are pending or have occurred. This may overload system resources such as memory devices and processing bandwidth. Accordingly, the present computing device 100 maintains the impact sensor 108 in an inactive state until a fall or other impact is pending. In other words, in the state depicted in FIG. 2A, the impact sensor 108 may be inactive, as indicated by the white circle.

In the example depicted in FIG. 2A, the motion sensor 102 may be actively monitoring the movement, and specifically, the movement in a vertical direction, of the computing device 100. As described above, throughout expected operation, the computing device 100 may move and change elevation. For example, a user may lift a laptop computing device 100 and place the laptop computing device 100 in a bag on the floor. If performed at a certain rate or speed, this movement may not pose a risk that might damage the computing device 100 or computing device components. However, this same movement may damage the computing device 100 and computing device components if they occur at an elevated rate, for example when the computing device 100 falls from the desk to the floor.

Accordingly, responsive to the motion sensor 102 movement data 104 indicating that the rate of elevation change is greater than some threshold amount, the processor 106 may activate the impact sensor 108. As depicted in FIG. 2B, detection of an above-threshold rate of elevation change and activation of the impact sensor 108 may occur during the initial stages of a fall of the computing device 100.

That is, as described above, the motion sensor 102 may be an elevation sensor that can detect differences in elevation at a resolution on the order of one foot. Accordingly, the elevation sensor may indicate that the computing device 100 has moved one foot or more in a threshold period of time and may pass this information to the processor 106 to activate the impact sensor 108, which activation is represented by the dark circle in FIG. 2B. As depicted in this figure, the impact sensor 108 is in a state where the impact sensor 108 can record impact data.

Note that in the example depicted in FIG. 2B, the motion sensor 102 may detect an above-threshold rate of change within microseconds of the computing device 100 falling from elevation. Also, the motion sensor 102 may be continuously active. As the motion sensor 102 consumes less power and does not store recorded data to a database, the same complications (i.e., power draw and recording non-salient data) do not arise as when the impact sensor 108 is continually active.

As depicted in FIG. 2C, by the time the computing device 100 impact occurs, the impact sensor 108 has been activated and records data associated with the impact. Such recorded data may take a variety of forms. For example, the impact sensor 108 may record a time and date associated with the impact, a force of the impact, and an acceleration leading up to the impact. As described above, such information may be used for a variety of purposes including predicting an end of life of the computing device 100 and/or a component thereof, providing a notification to a user of an effect of the impact, and transmitting telemetry data relating to the impact to a manufacturer for subsequent alteration of the computing device 100 and/or computing device components, among others. While particular reference is made to particular actions that may be taken following recordation of an impact event, other actions may be carried out.

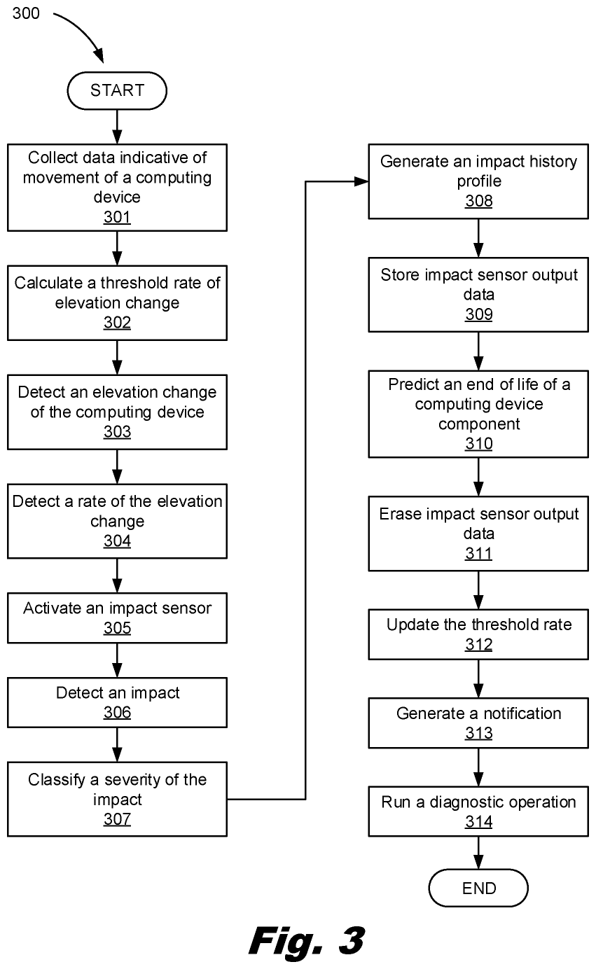

FIG. 3 is a flowchart of a method 300 for activating an impact sensor 108, according to an example. At step 301, the method 300 includes collecting data indicative of movement of the computing device 100. That is, as described above, the threshold rate by which the processor 106 determines whether to activate the impact sensor 108 may be determined based on usage data of the user. That is, different users may have different characteristics and patterns of usage. For example, a first user may leave a laptop on a desk while a second user may regularly move their laptop from a desk surface to a bag. Accordingly, during a calibration period the motion sensor 102 may collect movement data 104 indicating the expected and patterned movements of the computing device 100. At a later point in time, movements that are at a quicker rate than those indicated by the collected data may indicate an impact event which would trigger activation of the impact sensor 108.

Accordingly, at step 302, the method 300 includes calculating, using machine-learning and based on the data indicative of movement of the computing device 100, the threshold rate of elevation change which threshold rate is to trigger activation of an impact sensor 108 such as an accelerometer.

In calculating the threshold rate, the processor 106 may define impact events that are reportable, i.e., more likely to result in component damage and impact events that are not-reportable, i.e., less likely to result in component damage. That is, the processor 106 may execute instructions to define, using machine-learning, a first impact force as a reportable impact and a second impact force as a non-reportable impact. This may occur by mapping an impact force to the rate of elevation change associated with the impact force. For example, if a first impact force is less than a manufacturer or otherwise defined force which may not result in damage to a component, the elevation change recorded leading up to the first impact force may be designated as a non-impact elevation change. By comparison, the processor 106 may identify a rate of change of acceleration associated with a first impact force, which is an impact force identified as one likely to result in component damage, as the threshold rate.

At step 303, the method 300 includes detecting an elevation change of the computing device 100. That is, as described above in connection with FIGS. 1-2C, the motion sensor 102, which may be an elevation sensor, may detect an elevation of the computing device 100 and pass movement data 104 to the processor 106. The processor 106 may then calculate the rate of elevation change of the computing device 100. At step 304, the method 300 includes detecting a rate of elevation change. As described above, elevation change itself may not be indicative of potential damage to a computing device component. However, the rate, or speed at which the elevation of the computing device 100 changes may be an indicator of potential component damage. Accordingly, the processor 106 may determine an elevation change of the computing device 100 and a rate of elevation change of the computing device 100.

At step 305, the method 300 includes activating the impact sensor 108, which may be an accelerometer, responsive to the determined rate of elevation change being greater than a threshold rate, which threshold rate as described above may be set by a manufacturer or learned through machine-learning relating to a user's pattern of usage of the computing device 100.

As described above, in this state, the accelerometer or other impact sensor 108 is in a state to detect an impact and record data associated therewith. Accordingly, at step 306, the method 300 includes detecting a change of acceleration of the computing device 100 to detect an impact of the computing device.

At step 307, the method 300 may include classifying or determining a severity of the impact based on impact sensor output data. That is, the effect of an impact may be defined based on the force of the impact as well as a quantity of impacts. Accordingly, the processor 106 may classify a severity of the impact to indicate its effect, when considered individually or in the aggregate with other impacts, on the operation of the computing device 100 and/or computing device component. In an example, the impact may be classified as low, medium, or high, with each being associated with a range of impact forces.

At step 308, the method 300 includes generating an impact history profile for the computing device 100 based on accelerometer, or other impact sensor 108, data. That is, a computing device 100 may be subject to multiple impacts over the course of usage and the impact history profile may record each impact as well as other metadata associated with each impact. For example, each entry in the impact history profile may include a severity for the multiple impacts and the impact history profile may indicate a quantity of those impacts over time.

At step 309, the method 300 includes storing the accelerometer output data. That is, the computing device 100 may include a database which stores accelerometer, or other impact sensor 108, data, either individually or as part of an impact history profile. Such storage may be at the computing device 100 or may be remote from the computing device 100. In this later example, the computing device 100 may or may not have access to the remote location where the recorded data is stored.

At step 310, the method 300 includes predicting an end of life of a computing device component based on an impact. That is, each impact event may negatively impact the performance of a computing device component, and may affect the operational life of the computing device component. Accordingly, based on the impact history profile, the processor 106 may predict an expected life of the computing device component. In some examples, this includes a comparison of the impact history profile for the computing device 100 with historically collected impact history profiles. For example, the manufacturer may have a database of impact histories for computing devices 100 and the life of computing device components in those devices. In this example, the processor 106 may identify impact history profiles similar to the impact history profile of the current computing device 100 and use the lifetime of the components in the similar devices to predict the end of life of the component of the current computing device 100.

In another example, the historic data may be collected from computing devices 100 of other users. That is, other users may opt in to transmission of their impact data to a centralized server. In this example, the collected data may be used to quantity an effect of different classes of impacts on component life.

In an example, the prediction may be based on something other than a direct comparison of impact history profiles. For example, from the database relating impact events to component life, the processor 106 may predict the estimated end of life of a component based on the quantity of impact events of a particular classification a particular computing device 100 has experienced. For example, a database may include information indicating 1) an effect a low-class impact has on a central processing unit (CPU) life, 2) an effect a medium-class impact has on CPU life, and 3) an affect a high-class impact has on CPU life. From this information, and knowing that a particular computing device 100 has experienced one high-class impact, three medium-class impacts, and seven low-class impacts, the processor 106 may predict the end of life of the CPU.

In some examples, despite the impact sensor 108 being triggered, an impact may not be to a sufficient level to result in potential damage to a component. That is, the impact sensor 108 data may indicate a force less than the first impact force which defines a reportable impact. Accordingly, at step 311, the method 300 includes erasing impact sensor 108 output data responsive to the impact sensor 108 output data indicating an impact below a threshold force. Doing so may conserve the memory resources of the computing device 100 or remote storage resources as non-impact data is not recorded or relied on in training future impact detection.

In addition to erasing non-impact data, at step 312 the method 300 includes updating the threshold rate. For example, as described above, the impact sensor 108 is activated via a certain elevation rate of change being greater than a threshold rate. However, it may be the case that the impact force associated with the threshold elevation rate may not be greater than the first impact force and instead may be a non-reportable impact. Accordingly, in this example the processor 106 may update the threshold rate responsive to 1) the selective activation of the impact sensor 108 and 2) the impact sensor 108 output data indicating an impact below a threshold force. In other words, the rate of elevation change associated with a non-impact event may be used to re-set the threshold rate to be greater than the rate of elevation change associated with the non-impact event.

At step 313, the method 300 includes generating a notification. The notification may be to a user of the computing device 100 or to a manufacturer of the computing device 100 or computing device component. The notification may take a variety of forms. For example, the processor 106 may generate a notification indicating the predicted end of life of the computing device component. In another example, the processor 106 may generate a notification indicating a recommended action based on the impact. For example, the notification may suggest repair or replacement of a particular hardware component. In another example, the recommendation may pertain to a change in a manufacturing process. For example, due to a location within the computing device 100 or due to physical characteristics of a particular computing device component, that computing device component may be particularly susceptible to damage following impacts. Accordingly, a recommendation to a manufacturer may indicate adjustments to be made to prolong the life of the component or to indicate to a manufacturer that an adjustment should be made, without specifying the nature of the adjustment.

At step 314, the method 300 includes running a diagnostic operation following an impact to assess an effect of the impact on the computing device 100. That is, a particular impact event, either on its own, or by virtue of occurring after a sequence of other impact events, may have an immediate effect on computing device 100 performance. Accordingly, the processor 106 may execute instructions to perform a diagnostic operation to evaluate the performance and operability of different components of the computing device

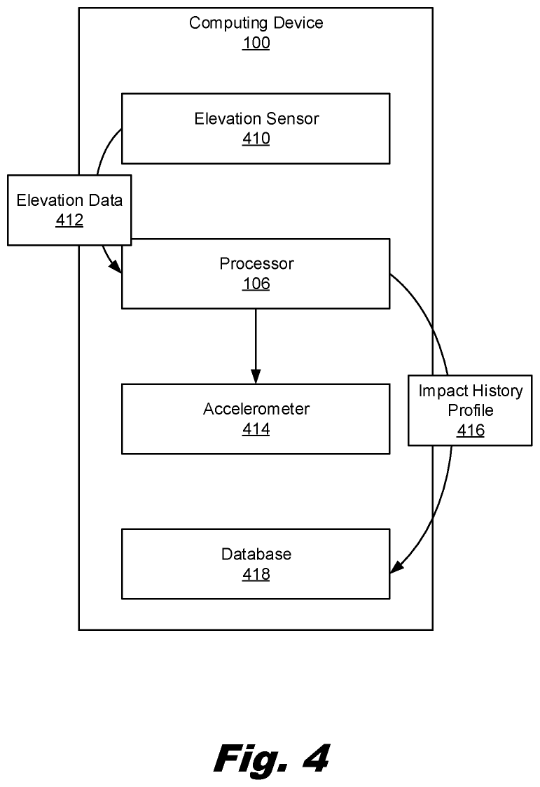

FIG. 4 depicts a computing device 100 for activating an accelerometer 414, according to an example. As described above, the computing device 100 may include a motion sensor 102. In the example depicted in FIG. 4, the motion sensor 102 is an elevation sensor 410 to detect an elevation of the computing device 100. As described above, such an elevation sensor 410 may be able to detect elevation differences on the order of 1 foot. That is, the elevation sensor 410 may be able to detect whether the computing device 100 is 5 feet above the ground or 4 feet above the ground. While particular reference is made to elevation above a ground surface, the elevation sensor 410 may be able to detect 1-foot increments of the elevation of the computing device 100 relative to a global scale, such as feet above sea level. Moreover, while particular reference is made to a particular increment value, in other examples the elevation sensor 410 may be able to detect elevation at other increments.

In the example, depicted in FIG. 4, the impact sensor 108 is an accelerometer 414 that detects a change of vertical acceleration of the computing device 100 to detect an impact of the computing device 100. This may be performed as described above.

The computing device 100 of FIG. 4 includes a processor 106, which as described above determines a rate of elevation change of the computing device from the elevation data 412 and selectively activates the accelerometer 414 responsive to the determined rate of elevation change being greater than a threshold rate. Also as described above, the processor 106 may classify a severity of the impact and generate an impact history profile 416 for the computing device 100 based on accelerometer, or other impact sensor, output data from the accelerometer 414. This impact history profile 416 may be stored on a database 418 which includes accelerometer output data from the accelerometer 414. As described above, the impact history profile 416 may include a number of impacts and a determined severity of each impact.

As describe above, the processor 106 may predict an end of life of a computing device component based on the impact history profile 416. In some examples, this may be based on a mapping between accelerometer output data and predicted end of life for the computing device component. Specifically, the database 418 may include a mapping between the impact history profile 416 and expected life of respective computing device components.

In an example as described above, the predicted end of life may be based on a comparison of the impact history profile 416 for the computing device 100 with historic data. As described above, this historic data may be collected from an additional computing device, such as a device under the control of a manufacturer ora computing device 100 in use by another user.

In yet another example, the processor 106 may predict the end of life for the computing device component based on metadata associated with the computing device component. That is, a computing device component manufacturer may determine certain impact classes that negatively impact the performance of a computing device component and may indicate the effect of those impacts on that computing device component. This information may be available to the processor 106. Accordingly, the processor 106 may consult this information in predicting the end of life for the affected computing device component.

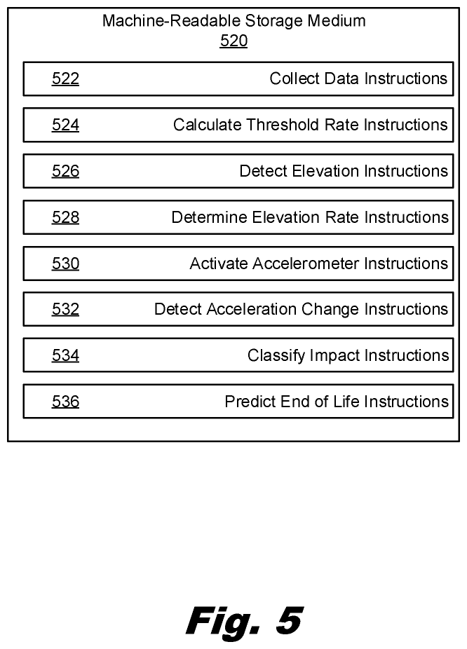

FIG. 5 depicts a non-transitory machine-readable storage medium 520 for activating an accelerometer 414, according to an example. As used in the present specification, the term “non-transitory” does not encompass transitory propagating signals.

To achieve its desired functionality, a computing device 100 includes various hardware components. Specifically, a computing device 100 includes a processor 106 and a machine-readable storage medium 520. The machine-readable storage medium 520 is communicatively coupled to the processor. The machine-readable storage medium 520 includes a number of instructions 522, 524, 526, 528, 530, 532, 534, 536 for performing a designated function. The machine-readable storage medium 520 causes the processor to execute the designated function of the instructions 522, 524, 526, 528, 530, 532, 534, 536. The machine-readable storage medium 520 can store data, programs, instructions, or any other machine-readable data that can be utilized to operate the computing device 100. Machine-readable storage medium 520 can store computer readable instructions that the processor 106 of the computing device 100 can process, or execute. The machine-readable storage medium 520 can be an electronic, magnetic, optical, or other physical storage device that contains or stores executable instructions. Machine-readable storage medium 520 may be, for example, Random Access Memory (RAM), an Electrically Erasable Programmable Read-Only Memory (EEPROM), a storage device, an optical disc, etc. The machine-readable storage medium 520 may be a non-transitory machine-readable storage medium 520.

Collect data instructions 522, when executed by the processor 106, cause the processor 106 to, collect data indicative of movement of the computing device 100. Calculate threshold rate instructions 524, when executed by the processor 106, cause the processor 106 to calculate, using machine-learning and based on data indicative of movement of the computing device 100, a threshold rate of elevation change to trigger activation of the accelerometer 414. Detect elevation instructions 526, when executed by the processor 106, cause the processor 106 to, detect an elevation of the computing device 100. Determine elevation rate instructions 528, when executed by the processor 106, cause the processor 106 to determine a rate of elevation change of the computing device 100. Activate accelerometer instructions 530, when executed by the processor 106, cause the processor 106 to activate an accelerometer 414 of the computing device 100 responsive to the determined rate of elevation change being greater than the threshold rate. Detect acceleration change instructions 532, when executed by the processor 106, cause the processor 106 to detect a change of acceleration of the computing device 100 to identify an impact of the computing device 100. Classify impact instructions 534, when executed by the processor 106, cause the processor 106 to classify a severity of the impact. Predict end of life instructions 536, when executed by the processor 106, cause the processor 106 to predict an end of life of a computing device component based on an identified impact.

What is claimed is:

1. A computing device, comprising:
a motion sensor to detect movement of the computing device;
a processor to:
determine a rate of movement change of the computing device; and
activate an impact sensor of the computing device responsive to a determined rate of movement change being greater than a threshold rate; and
the impact sensor to detect an impact of the computing device and record data associated with the impact.

2. The computing device of claim 1, determine a severity of an identified impact based on impact sensor output data.

3. The computing device of claim 1, wherein the processor is to erase impact sensor output responsive to impact sensor output data indicating an impact below a threshold force.

4. The computing device of claim 1, wherein the motion sensor is to measure an air pressure at the computing device and correlate the air pressure to an elevation.

5. The computing device of claim 1, wherein the impact sensor is a multi-axis accelerometer.

6. The computing device of claim 1, wherein the motion sensor and the processor are to determine the threshold rate during a calibration period and based on computing device usage.

7. The computing device of claim 1, wherein the processor is to update the threshold rate responsive to:
selective activation of the impact sensor; and
impact sensor output data indicating an impact below a threshold force.

8. The computing device of claim 1, wherein the motion sensor is an elevation sensor to differentiate elevation at one-foot increments.

9. A computing device, comprising:
an elevation sensor to detect an elevation of the computing device;
an accelerometer to detect a change of acceleration of the computing device to detect an impact of the computing device;
a processor to:
determine a rate of elevation change of the computing device;
activate the accelerometer responsive to a determined rate of elevation change being greater than a threshold rate;
classify a severity of the impact;
generate an impact history profile for the computing device based on accelerometer output data; and
predict an end of life of a computing device component based on the impact history profile; and
a database to store accelerometer output data.

10. The computing device of claim 9, wherein the database further comprises a mapping between accelerometer output data and predicted end of life for the computing device component.

11. The computing device of claim 9, wherein the impact history profile indicates a number of impacts and a determined severity of an impact.

12. The computing device of claim 9, wherein the processor is to generate a notification indicating a predicted end of life of the computing device component.

13. The computing device of claim 9, wherein the processor is to generate a notification indicating a recommended action based on the impact.

14. The computing device of claim 9, wherein the processor is to predict the end of life for the computing device component based on a comparison of the impact history profile for the computing device with historic data.

15. The computing device of claim 14, wherein the historic data is collected from an additional computing device.

16. The computing device of claim 9, wherein the processor is to predict the end of life for the computing device component based on metadata associated with the computing device component.

17. A non-transitory machine-readable storage medium encoded with instructions executable by a processor of a computing device to, when executed by the processor, cause the processor to:
collect data indicative of movement of the computing device;
calculate, using machine-learning and based on data indicative of movement of the computing device, a threshold rate of elevation change to trigger activation of the accelerometer;
detect an elevation of the computing device;
determine a rate of elevation change of the computing device;
responsive to the determined rate of elevation change being greater than the threshold rate, activate an accelerometer of the computing device;
detect a change of acceleration of the computing device to identify an impact of the computing device;
classify a severity of the impact; and
predict an end of life of a computing device component based on an identified impact.

18. The non-transitory machine-readable storage medium of claim 17, further comprising instructions executable by the processor of the computing device to, execute a diagnostic operation following an impact to assess an effect of the impact on the computing device.

19. The non-transitory machine-readable storage medium of claim 17, further comprising instructions to, define using machine learning:
a first impact force as a reportable impact; and
a second impact force as a non-reportable impact.

20. The non-transitory machine-readable storage medium of claim 19, wherein the instructions to calculate the threshold rate of elevation change to trigger activation of the accelerometer comprises instructions to identify a rate of change of acceleration associated with the first impact force as the threshold rate.
